(19) United States
(12) Patent Application Publication
(10) Pub. No.: US 2023/0058075 A1
(43) Pub. Date: Feb. 23, 2023

(54) MOLDED ADSORBENT AND WATER PURIFICATION CARTRIDGE

(71) Applicant: LIXIL Corporation, Tokyo (JP)

(72) Inventors: Keiichi HIRATA, Koto-ku, Tokyo (JP); Naoya TAMURA, Koto-ku, Tokyo (JP); Kazuichi OHASHI, Koto-ku, Tokyo (JP); Kazuhiro SATO, Koto-ku, Tokyo (JP)

(73) Assignee: LIXIL Corporation, Tokyo (JP)

(21) Appl. No.: 17/797,159

(22) PCT Filed: Jan. 7, 2021
(86) PCT No.: PCT/JP2021/000269

§ 371 Date: Aug. 3, 2022

(30) Foreign Application Priority Data
Feb. 5, 2020 (JP) 2020-017610

(51) Int. Cl. B01J 20/20; B01J 20/16; B01J 20/28

(52) U.S. Cl. CPC B01J 20/20; B01J 20/165; B01J 20/2803; B01J 20/28004; B01J 2220/62

(57) ABSTRACT

To improve a performance for removing soluble lead and finely particulate lead. A molded adsorbent (1) includes an adsorption material (3) and a fibrous binder (5). The adsorption material (3) contains activated carbon (3A) and zeolite (3B). A central particle size D50 of the activated carbon (3A) is 27 μm or more and 35 μm or less, a central particle size D50 of the zeolite (3B) is 24 μm or more and 31 μm or less, and a content rate of the zeolite (3B) is 10 mass % or more and 70.5 mass % or less.

### CROSS REFERENCE TO RELATED APPLICATIONS

This application is a national stage application under 35 U.S.C. 371 of International Patent Application No. PCT/JP2021/000269, filed Jan. 7, 2021, which claims priority of Japanese Application No. 2020-017610, filed Feb. 5, 2020, the entire contents of each priority application of which are incorporated herein by reference.

### FIELD OF THE DISCLOSURE

The present disclosure relates to a molded adsorbent and a water purification cartridge.

### BACKGROUND OF THE DISCLOSURE

A water treatment filter is disclosed in WO 2014/061740. The water treatment filter of Patent Literature 1 includes a cylindrical filter containing granular activated carbon having a central particle size of from 30 to 80 μm and a fibrillated fibrous binder. An arithmetic average waviness of an outer surface on an upstream side of the water treatment filter is adjusted to 30 μm or less, and an arithmetic average height of a cross-sectional curve thereof is adjusted to from 35 to 45 μm.

### SUMMARY OF THE DISCLOSURE

The water treatment filter of Patent Literature 1 does not necessarily have a sufficient performance for removing soluble lead and finely particulate lead. An object of the present disclosure is to improve a performance for removing soluble lead and finely particulate lead.

A molded adsorbent including an adsorption material and a fibrous binder, wherein the adsorption material contains activated carbon and zeolite, wherein a central particle size D50 of the activated carbon is 27 μm or more and 35 μm or less, wherein a central particle size D50 of the zeolite is 24 μm or more and 31 μm or less, and wherein a content rate of the zeolite is 10 mass % or more and 70.5 mass % or less.

### BRIEF DESCRIPTION OF THE FIGURES

FIG. 1 is an explanatory view schematically showing a configuration of an exemplary molded adsorbent.

FIG. 2 is a front view of an example of a water purification cartridge including the molded adsorbent.

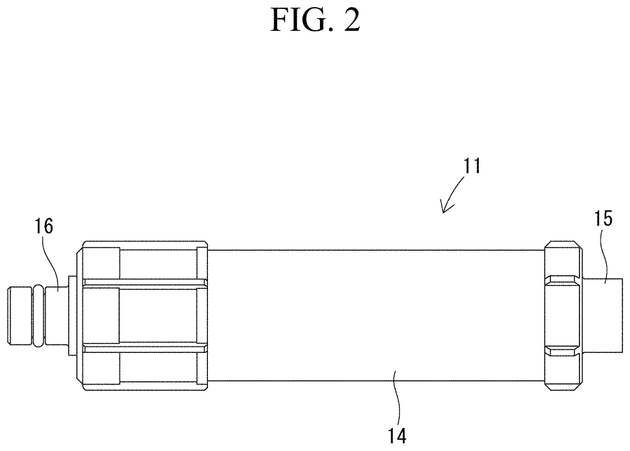

FIG. 3 is a cross-sectional view of the water purification cartridge shown in FIG. 2.

### DETAILED DESCRIPTION OF THE EMBODIMENT

### 1. Molded Adsorbent 1

### (1) Configuration of Molded Adsorbent 1

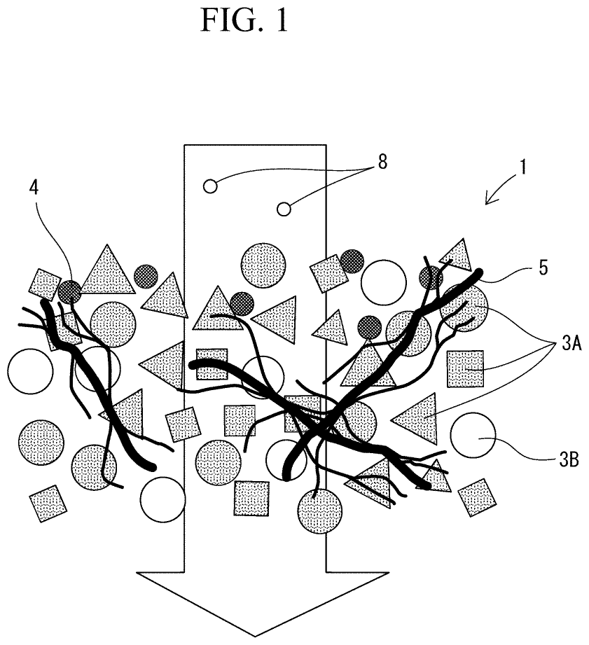

A molded adsorbent 1 includes an adsorption material 3 and a fibrous binder 5. As schematically shown in FIG. 1, the adsorption material 3 contains activated carbon 3A indicated by black circles, black squares, and black triangles, and zeolite 3B indicated by white circles. By incorporating the activated carbon 3A and the zeolite 3B in the adsorption material 3, the molded adsorbent 1 can be adapted to the NFS standard (NSF/ANSI 53) for removing lead. The activated carbon 3A may be in either a granular form or a powder form. The adsorption material 3 may contain, for example, other adsorption substances such as titanium silicate, sodium titanate, aluminosilicate, and titanium oxide. An arrow in FIG. 1 indicates a flow of water containing soluble lead 8, and reference numeral 4 represents a finely particulate substance to be removed.

From the viewpoint of reducing a pressure loss, a lower limit of a central particle size D50 of the activated carbon 3A is 27 μm or more, preferably 28 μm or more, and more preferably 29 μm or more. An upper limit of the central particle size D50 of the activated carbon 3A is 35 μm or less, preferably 34 μm or less, and more preferably 33 μm or less, from the viewpoint of improving a fine particle removal rate. The central particle size D50 of the activated carbon 3A is 27 μm or more and 35 μm or less, preferably 28 μm or more and 34 μm or less, and more preferably 29 μm or more and 33 μm or less.

The central particle size D50 of the activated carbon 3A can be measured by a laser diffraction/scattering particle size distribution measuring apparatus.

From the viewpoint of reducing the pressure loss, a lower limit of a central particle size D50 of the zeolite 3B is 24 μm or more, preferably 25 μm or more, and more preferably 26 μm or more. An upper limit of the central particle size D50 of the zeolite 3B is 31 μm or less, preferably 30 μm or less, and more preferably 29 μm or less, from the viewpoint of effectively removing soluble lead. The central particle size D50 of the zeolite 3B is 24 μm or more and 31 μm or less, preferably 25 μm or more and 30 μm or less, and more preferably 26 μm or more and 29 μm or less.

The central particle size D50 of the zeolite 3B can be measured by a laser diffraction/scattering particle size distribution measuring apparatus.

When an amount of the molded adsorbent 1 is 100 mass %, a lower limit of the content rate of the zeolite 3B is 10 mass % or more, preferably 12 mass % or more, and more preferably 15 mass % or more, from the viewpoint of effectively removing soluble lead. From the viewpoint of moldability of the molded adsorbent 1, an upper limit of the content rate of the zeolite 3B is 70.5 mass % or less, preferably 60 mass % or less, more preferably 50 mass % or less. The content rate of the zeolite 3B is 10 mass % or more and 70.5 mass % or less, preferably 12 mass % or more and 60 mass % or less, and more preferably 15 mass % or more and 50 mass % or less.

From the viewpoint of reducing the pressure loss, a lower limit of a central particle size D50 of the adsorption material 3 is 21 μm or more, preferably 24 μm or more, and more preferably 27 μm or more. An upper limit of the central particle size D50 of the adsorption material 3 is 43 μm or less, preferably 40 μm or less, and more preferably 37 μm or less, from the viewpoint of improving the fine particle removal rate. The central particle size D50 of the adsorption material 3 is 21 μm or more and 43 μm or less, preferably 24 μm or more and 40 μm or less, and more preferably 27 μm or more and 37 μm or less.

A lower limit of a content rate of the adsorption material 3 having a particle size of 10 μm or less is preferably 1.7 vol % or more, more preferably 2.3 vol % or more, and still more preferably 2.9 vol % or more, from the viewpoint of improving the fine particle removal rate. An upper limit of the content rate of the adsorption material 3 having a particle size of 10 μm or less is preferably 13.7 vol % or less, more preferably 13.1 vol % or less, and still more preferably 12.5 vol % or less, from the viewpoint of reducing the pressure loss. The content rate of the adsorption material 3 having a particle size of 10 μm or less is preferably 1.7 vol % or more and 13.7 vol % or less, more preferably 2.3 vol % or more and 13.1 vol % or less, and still more preferably 2.9 vol % or more and 12.5 vol % or less. The content rate of the adsorption material 3 having a particle size of 10 μm or less means a volume ratio of the adsorption material 3 having a particle size of 10 μm or less contained in a total amount, 100 vol %, of the adsorption material 3. The adsorption material 3 having a particle size of 10 μm or less has a particle size larger than 0 μm.

The central particle size D50 of the adsorption material 3 and the content rate of the adsorption material 3 having a particle size of 10 μm or less can be measured by a laser diffraction/scattering particle size distribution measuring apparatus.

From the viewpoint of moldability of the molded adsorbent 1, when the amount of the molded adsorbent 1 is 100 mass %, a content of the activated carbon 3A is preferably 23.5 mass % or more and 84 mass % or less, and a content of the fibrous binder 5 is preferably 2 mass % or more and 10 mass % or less. In this case, it is more preferable that the content of the activated carbon 3A be 35 mass % or more and 79 mass % or less, and that the content of the fibrous binder 5 be 3 mass % or more and 9 mass % or less, and it is still more preferable that the content of the activated carbon 3A be 50 mass % or more and 74 mass % or less, and that the content of the fibrous binder 5 be 4 mass % or more and 8 mass % or less.

The pressure loss of the molded adsorbent 1 is preferably 0.07 MPa or more and 0.15 MPa or less. When the pressure loss is within this range, a practical molded adsorbent 1 is obtained. The pressure loss means a pressure loss at a flow rate of 2.5 L/min when water passes in a direction from an outer peripheral surface to an inner peripheral surface in a filtration volume of 37.4 mL of a cartridge filter having an outer diameter of 24.4 mm, an inner diameter of 8.1 mm and a length of 90.0 mm.

### (2) Effect of Molded Adsorbent 1

The molded adsorbent 1 has a low pressure loss and a high removal rate of soluble lead (Pb²⁺, Pb(OH)₂, Pb(OH)⁺) and finely particulate lead.

### 2. Water Purification Cartridge 11

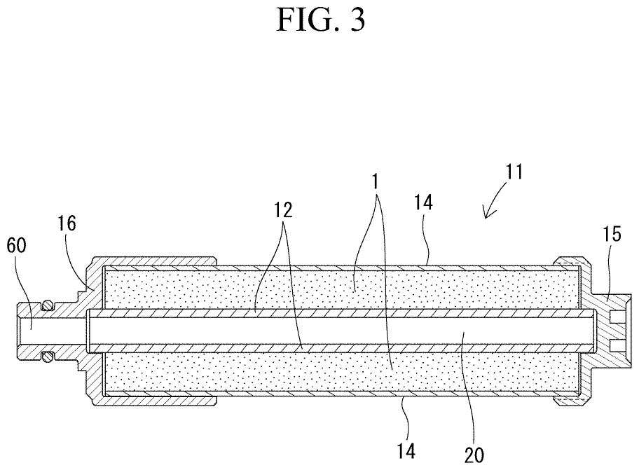

As shown in FIG. 3, the water purification cartridge 11 includes the molded adsorbent 1. A shape and a structure of the water purification cartridge 11 are not particularly limited. A preferred example of the water purification cartridge 11 will be described below.

### (1) Structure of Water Purification Cartridge 11

The water purification cartridge 11 has a cylindrical shape. The water purification cartridge 11 includes a core 12, the molded adsorbent 1, a nonwoven fabric 14, and sealing caps 15 and 16. The core 12 has a cylindrical shape and is disposed on an innermost side of the water purification cartridge 11. The core 12 is formed with pores that allow water to pass from the outside to the inside, and a flow path 20 is formed inside. As the core 12, any material can be used. Examples of a material for the core 12 include porous ceramics, porous metal filters, and hard nonwoven fabrics.

The molded adsorbent 1 has a cylindrical shape and is disposed on an outer peripheral surface of the core 12. The nonwoven fabric 14 is disposed on an outer peripheral surface of the molded adsorbent 1. As the nonwoven fabric 14, for example, a nonwoven fabric defined by JIS L0222 can be used. The type of fibers used as a raw material for the nonwoven fabric 14 is not particularly limited.

The sealing cap 15 covers one end side of the molded adsorbent 1 to close one side of the flow path 20. The sealing cap 16 covers the other end side of the molded adsorbent 1. The sealing cap 16 is formed with a discharge port 60 from which the water flowing through the flow path 20 is discharged.

### (2) Method for Manufacturing Water Purification Cartridge 11

An example of a method for manufacturing the water purification cartridge 11 will be described below. The method for manufacturing the water purification cartridge 11 includes a mixing step, a suction molding step, a drying step, a surface polishing step, a nonwoven fabric winding step, and a sealing step.

In the mixing step, a slurry is obtained by mixing a particulate substance as a raw material for the molded adsorbent 1, a fibrous binder, water, and the like. In the suction molding step, the molded adsorbent 1 is molded. In the suction molding step, one end side of the flow path 20 of the core 12 is connected to a suction pump via a hose. At this time, the other end side of the flow path 20 of the center core 12 is sealed. The core 12 connected to the suction pump is immersed in the above-described slurry stored in a container, and a suction pump including a vacuum pump or the like is operated. Water in the slurry permeates through the core 12, and a mixture of the particulate substance and the fibrous binder remains on a surface of the core 12 and gradually accumulates to form the molded adsorbent 1. Water in the slurry sucked by the suction pump is discharged through a drain channel. After the molded adsorbent 1 is formed to a prescribed thickness by operating the suction pump, the center core 12 is pulled up from the slurry.

In the drying step, the molded adsorbent 1 molded in the suction molding step is dried. By drying the molded adsorbent 1 in the drying step, the core 12 and the molded adsorbent 1 can be integrated. In the surface polishing step, the outer peripheral surface of the molded adsorbent 1 is polished. In the nonwoven fabric winding step, the nonwoven fabric 14 is wound around the outer peripheral surface of the molded adsorbent 1 polished in the surface polishing step. In the sealing step, the sealing cap 15 is attached to one end side of the molded adsorbent 1 around which the nonwoven fabric 14 is wound, and the sealing cap 16 is attached to the other end side thereof

### (3) Effect of Water Purification Cartridge 11

The water purification cartridge 11 including the molded adsorbent 1 has a low pressure loss and a high removal rate of soluble lead (Pb²⁺, Pb(OH)_{2,} Pb(OH)⁺) and finely particulate lead.

Hereinafter, the present disclosure will be described more specifically by way of Examples. Experimental Examples 1-11, 1-13, 1-15, 1-16, 2-1, 2-2, 2-3, 2-4, 2-5, 3-1, 3-2, 3-3, 3-4, 3-5, 3-6, and 3-7 are examples, and other experimental examples are comparative examples.

### 1. Preparation of Molded Adsorbent

Molded adsorbents of Experimental Examples 1-1 to 1-26, Experimental Examples 2-1 to 2-5, and Experimental Examples 3-1 to 3-8 were prepared as follows. Slurries were prepared at mixing ratios shown in Tables 1, 3, and 4. Details of each component are as follows.

Binder: Bi-PUL 50 TWF (fibrillated fiber of acrylonitrile), Toyobo Co., Ltd. and Japan Exlan Company, Limited

Activated carbon (ultrafine grain): D50=10 μm

Activated carbon (extra fine grain): Grinded and classified granular Shirasagi TC-50, Osaka Gas Chemicals Co., Ltd., D50 =21 μm

Activated carbon (fine grain): Shirasagi TC-20, Osaka Gas Chemicals Co., Ltd., D50 =35 μm

Activated carbon (medium grain): Shirasagi TC-50, Osaka Gas Chemicals Co., Ltd., D50 =73 μm

Activated carbon (coarse grain): Shirasagi TC-100, Osaka Gas Chemicals Co., Ltd., D50 =130 μm

Lead removing material A: zeolite, BASF Japan, ATS™ MEDIA NSF/ANSI61 D50=29 μm

Lead removing material B: zeolite, D50=24 μm

TABLE 1

| | | | | | | | | Grain size | | | | | |
|---|---|---|---|---|---|---|---|---|---|---|---|---|---|
| | Blending ratio (mass %) | | | | | | | | | | | | Lead |
| | | Activated carbon | | | | | Lead | Total powder | | | Cumulative | Activated | removing |
| | | | Extra | | | | removing | distribution | | | total of 10 | carbon | material |
| | | Ultrafine | fine | Fine | Medium | Coarse | material | (μm) | | | μm powder | distribution | distribution |
| Example | Binder | grain | grain | grain | grain | grain | A | D10 | D50 | D90 | (vol %) | D50 (μm) | D50 (μm) |
| 1-1 | 6 | 94 | | — | — | — | — | 7 | 10 | 15 | 54.3 | 10 | — |
| 1-2 | 6 | 20 | 74 | — | — | — | — | 10 | 19 | 31 | 11.5 | 19 | — |
| 1-3 | 6 | — | — | — | 94 | — | — | 47 | 73 | 125 | 0.0 | 73 | — |
| 1-4 | 6 | — | — | — | — | 94 | — | 92 | 130 | 182 | 0.0 | 130 | — |
| 1-5 | 6 | 6 | — | — | 88 | — | — | 36 | 62 | 106 | 1.1 | 62 | — |
| 1-6 | 6 | — | 94 | — | — | — | — | 13 | 21 | 33 | 3.8 | 21 | — |
| 1-7 | 6 | 6 | 67 | 21 | — | — | — | 12 | 21 | 41 | 5.7 | 21 | — |
| 1-8 | 6 | — | 70 | 24 | — | — | — | 13 | 22 | 42 | 3.8 | 22 | — |
| 1-9 | 6 | 20 | 37 | 18.5 | 18.5 | — | — | 10 | 23 | 73 | 10.5 | 23 | — |
| 1-10 | 6 | — | — | — | — | — | 94 | 9 | 29 | 61 | 11.9 | — | 29 |
| 1-11 | 6 | — | — | 23.5 | — | — | 70.5 | 8 | 29 | 58 | 13.7 | 35 | 29 |
| 1-12 | 6 | 18 | — | 76 | — | — | — | 11 | 30 | 60 | 8.7 | 30 | — |
| 1-13 | 6 | 10 | — | 59 | — | — | 25 | 11 | 30 | 60 | 8.5 | 31 | 29 |
| 1-14 | 6 | 12 | — | 82 | — | — | — | 12 | 32 | 61 | 6.1 | 32 | — |
| 1-15 | 6 | — | — | 47 | — | — | 47 | 13 | 32 | 60 | 6.0 | 35 | 29 |
| 1-16 | 6 | 5 | — | 64 | — | — | 25 | 13 | 32 | 61 | 5.7 | 33 | 29 |
| 1-17 | 6 | 9 | — | 85 | — | — | — | 13 | 33 | 62 | 4.9 | 33 | — |
| 1-18 | 6 | 6 | — | 88 | — | — | — | 14 | 33 | 62 | 3.6 | 33 | — |
| 1-19 | 6 | 3 | — | 91 | — | — | — | 15 | 34 | 62 | 2.9 | 34 | — |
| 1-20 | 2 | — | — | 98 | — | — | — | 16 | 35 | 62 | 1.8 | 35 | — |
| 1-21 | 10 | — | — | 90 | — | — | — | 16 | 35 | 62 | 1.8 | 35 | — |
| 1-22 | 6 | — | — | 94 | — | — | — | 16 | 35 | 62 | 1.7 | 35 | — |
| 1-23 | 6 | 9 | — | 65 | 20 | — | — | 14 | 38 | 77 | 4.6 | 38 | — |
| 1-24 | 6 | 3 | — | 68 | 23 | — | — | 16 | 40 | 79 | 2.4 | 40 | — |
| 1-25 | 6 | 13 | — | 53 | 28 | — | — | 13 | 41 | 89 | 6.1 | 41 | — |
| 1-26 | 6 | 20 | — | 37 | 37 | — | — | 10 | 43 | 95 | 9.5 | 43 | — |

TABLE 2

| | | Cartridge performance | |
|---|---|---|---|
| | | Pressure | Fine particle |
| | Moldable | loss | removal |
| Example | or not | (MPa) | rate (%) |
| 1-1 | Moldable | 0.39 | 99 |
| 1-2 | Moldable | 0.16 | 100 |
| 1-3 | Moldable | 0.02 | 50 |
| 1-4 | Moldable | 0.01 | 14 |
| 1-5 | Moldable | 0.03 | 72 |
| 1-6 | Moldable | 0.10 | 98 |
| 1-7 | Moldable | 0.11 | 97 |
| 1-8 | Moldable | 0.09 | 95 |
| 1-9 | Moldable | 0.13 | 100 |
| 1-10 | Not moldable | — | — |
| 1-11 | Moldable | 0.11 | 84 |
| 1-12 | Moldable | 0.11 | 96 |
| 1-13 | Moldable | 0.11 | 91 |
| 1-14 | Moldable | 0.09 | 96 |
| 1-15 | Moldable | 0.09 | 84 |
| 1-16 | Moldable | 0.09 | 84 |
| 1-17 | Moldable | 0.09 | 97 |
| 1-18 | Moldable | 0.08 | 96 |
| 1-19 | Moldable | 0.07 | 95 |
| 1-20 | Moldable | 0.09 | 96 |
| 1-21 | Moldable | 0.05 | 85 |
| 1-22 | Moldable | 0.07 | 95 |
| 1-23 | Moldable | 0.07 | 95 |
| 1-24 | Moldable | 0.06 | 91 |
| 1-25 | Moldable | 0.08 | 91 |
| 1-26 | Moldable | 0.09 | 97 |

TABLE 3

| | | | | | | Grain size | |
|---|---|---|---|---|---|---|---|
| | | | | | | Lead | |
| | Blending ratio (mass %) | | | | | removing | Cartridge |
| | | Activated | | Lead | Lead | material | performance |
| | | carbon | | removing | removing | distribution | Removal |
| | | Ultrafine | Fine | material | material | D50 | rate |
| Example | Binder | grain | grain | A | B | (μm) | (%) |
| 2-1 | 6 | — | 79 | 15 | — | 29 | 84% |
| 2-2 | 6 | — | 74 | 20 | — | 29 | 95% |
| 2-3 | 6 | — | 84 | — | 10 | 24 | 94% |
| 2-4 | 6 | — | 79 | — | 15 | 24 | 99% or more |
| 2-5 | 6 | 5 | 64 | 25 | — | 29 | 99% or more |

TABLE 4

| | Blending ratio (mass %) | | | | | | Grain size | | |
|---|---|---|---|---|---|---|---|---|---|
| | | Activated | | | Lead | Lead | Total powder | | |
| | | carbon | | | removing | removing | distribution | | |
| | | Ultrafine | Fine | Medium | material | material | (μm) | | |
| Example | Binder | grain | grain | grain | A | B | D10 | D50 | D90 |
| 3-1 | 6 | — | 74 | — | 20 | — | 14 | 33 | 61 |
| 3-2 | 6 | — | 64 | — | 30 | — | 14 | 33 | 61 |
| 3-3 | 6 | 20 | 54 | — | 20 | — | 9 | 26 | 57 |
| 3-4 | 6 | 17.5 | 51.5 | — | 25 | — | 9 | 26 | 56 |
| 3-5 | 6 | 5 | 64 | — | 25 | — | 12 | 31 | 60 |
| 3-6 | 6 | 5 | 64 | — | 25 | — | 12 | 31 | 60 |
| 3-7 | 6 | — | 79 | — | — | 15 | 13 | 31 | 59 |
| 3-8 | 6 | — | — | 89 | 5 | — | — | 70 | — |
| | | | Grain size | | | | | | |
| | | | | | Lead | | | | |
| | | | Cumulative | Activated | removing | | Cartridge performance | | |
| | | | total of | carbon | material | | | Initial | Final |
| | | | 10 μm | distribution | distribution | | Pressure | removal | removal |
| | | | powder | D50 | D50 | Density | loss | rate | rate |

| Example | (vol %) | (μm) | (μm) | (g/mL) | (Mpa) | (%) | (%) |
|---|---|---|---|---|---|---|---|
| 3-1 | 3.2 | 35 | 29 | 0.45 | 0.07 | 92 | 91 |
| 3-2 | 4.0 | 35 | 29 | 0.48 | 0.08 | 99 | 96 |
| 3-3 | 13.5 | 27 | 29 | 0.49 | 0.15 | 100 | 99 |
| 3-4 | 13.2 | 28 | 29 | 0.51 | 0.15 | 97 | 96 |
| 3-5 | 6.2 | 33 | 29 | 0.47 | 0.09 | 99 | 98 |
| 3-6 | 6.2 | 33 | 31 | 0.48 | 0.09 | 100 | 98 |
| 3-7 | 5.2 | 35 | 24 | 0.38 | 0.09 | 99 | 99 |
| 3-8 | 0.1 | 73 | 29 | 0.37 | 0.03 | 50 | 10 |

A ceramic core material (outer diameter: φ 8.1 mm, inner diameter: φ 5.0 mm) as a core was mounted to a molding machine, and sucked in a slurry to increase the thickness to form a molded adsorbent. The molded adsorbent was dried and polished, a nonwoven fabric was wound, and a cap was bonded to form a water purification cartridge. A size of the cartridge (molded adsorbent portion) was set to an outer diameter φ of 24.4 mm, an inner diameter φ of 8.1 mm, and a length of 90 mm. A grain size was determined by measuring the slurry excluding the binder with a particle size distribution measuring apparatus. Details of the particle size distribution measuring apparatus and measurement conditions will be indicated below. A measured value obtained by this measurement is a particle size distribution of the particulate substance in the slurry. The particle size of the particulate substance in the slurry does not change even in the molded adsorbent after drying. The particle size distribution of the particulate substance in the slurry reflects the particle size distribution of the particulate substance in the molded adsorbent after drying.

Laser diffraction/scattering particle size distribution measuring apparatus: Microtrac MT3300EXII

Distribution: volume

Solvent: water

Scale grade: particle size 0.021 um to 2000 um

Number of channels: 132

### 2. Performance Evaluation of Water Purification Cartridge

### 2.1 Experiment 1

Experimental Examples 1-1 to 1-26 shown in Table 1 were tested as follows to evaluate their performance. In this test, the performance for removing particulate lead was evaluated.

### (1) Test Method

A test conforming to NFS/ANSI 42 Particle Removal Test Grade I was conducted. A particle counter was used for analysis. Specifically, the test was conducted by the following procedure.

(1-1) ISO TEST DUST 12103-1 A2 fine was dispersed in water. The number of particles of 0.5 to 1 μm is about 2 million.

(1-2) The water purification cartridge was mounted to a housing, and water was passed for 1 minute at SV=4000/h (2.5 L/min).

(1-3) The filtered water was collected, and the number of particles (0.5 to 1 μm) was measured.

### (2) Method for Measuring Pressure Loss

(2-1) A pressure gauge was mounted to a front and a back of the empty housing, water was passed at 2.5 L/min without mounting any water purification cartridge, and a pressure difference (pressure A) between at the front and at the back at that time was measured.

(2-2) The water purification cartridge was mounted to the housing, and water was passed at SV =4000h (2.5 L/min) for 10 minutes, and a pressure difference (pressure B) between at the front and at the back at that time was measured.

(2-3) A difference between the pressure A and the pressure B was defined as a pressure loss of the water purification cartridge.

The test according to NSF is conducted until the flow rate of the water purification cartridge falls to 50% or less of the initial flow rate. In the performance evaluation described herein, the removal rate gradually increases due to clogging. Thus, only the initial filtered water having the lowest removal rate was evaluated.

### (3) Results and Discussion

The results are shown in Table 2 above. Experimental Examples 1-11, 1-13, 1-15, and 1-16 satisfy all of the following aspects 1 to 5.

[Aspect 1]: The adsorption material contains activated carbon and zeolite.

[Aspect 2]: The central particle size D50 of the activated carbon is 27 μm or more and 35 μm or less.

[Aspect 3]: The central particle size D50 of the zeolite is 24 μm or more and 31 μm or less.

[Aspect 4]: The content rate of the zeolite is 10 mass % or more and 70.5 mass % or less.

[Aspect 5]: A molded adsorbent can be prepared by molding.

On the other hand, the other experimental examples do not satisfy the following aspect. Experimental Examples 1-1, 1-2, 1-3, 1-4, 1-5, 1-6, 1-7, 1-8, 1-9, 1- 12, 1-14, 1-17, 1-18, 1-19, 1-20, 1-21, 1-22, 1-23, 1-24, 1-25, and 1-26 do not satisfy Aspect 1.

Experimental Example 1-10 do not satisfy Aspect 4 since the content rate of the zeolite is 94 mass %, and also do not satisfy Aspect 5 since molding cannot be performed.

In Experimental Examples 1-11, 1-13, 1-15, and 1-16, the pressure loss was 0.15 MPa or less, and the fine particle removal rate was 80% or more. These experimental examples were confirmed to be excellent in performance. Experimental Examples 1-11, 1-13, 1-15, and 1-16 also satisfy the following aspects 6 and 7, and thus it was confirmed that the experimental examples satisfying Aspects 6 and 7, in addition to Aspects 1 to 5, are excellent in performance.

[Aspect 6]: The central particle size D50 of the adsorption material (indicated as “D50 in the total powder distribution (μm)” in the table) is 21 μm or more and 43 μm or less.

[Aspect 7]: The content rate of the adsorption material having a particle size of 10 μm or less (described as “Cumulative total of 10 μm powder (vol %)” in the table) is 1.7 vol % or more and 13.7 vol % or less.

### 2.2 Experiment 2

Experimental Examples 2-1 to 2-5 shown in Table 3 were tested as follows to evaluate their performance. In this test, the performance for removing soluble lead was evaluated.

### (1) Test Method

A test simulating the NFS/ANSI 53 lead removal test (pH 8.5) was conducted. In this test, the raw water was adjusted basically in the same way as NSF. However, water was passed in a continuous test. Details of the test will be indicated below.

(1.1) Calcium chloride, magnesium sulfate, sodium hydrogen carbonate, and hypochlorous acid are added to RO water to adjust the hardness, alkalinity, and chlorine concentration, and the pH is adjusted to 8.5 with either one of an aqueous hydrochloric acid solution and an aqueous sodium hydroxide solution.

(1.2) An aqueous lead nitrate solution is added and raw water containing soluble lead and particulate lead and having a total lead concentration of 150 ppb is adjusted.

(1.3) The cartridge is mounted to the housing, and water is passed at 2.5 L/min.

(1.4) Filtered water after water passing for a certain period of time is collected, and measured for lead concentration with an atomic absorption spectrophotometer. The removal rate is evaluated based on the amount of the total lead concentration reduced, and the removal rate at the time when 1000 L of water is passed is defined as the performance of the cartridge. <Ratio of total lead concentration (150 ppb) in raw water>

Soluble lead: from 60 to 80% (from 90 to 120 ppb)

Particulate lead: from 20 to 40% (from 30 to 60 ppb) in which the ratio of finely particulate lead (from 0.1 to 1.2 μm) is 20% or more (6 to 12 ppb or more).

### (2) Results and Discussion

The results are shown in Table 3 above. Experimental Examples 2-1 to 2-5 satisfy all of the following aspects 1 to 5. Table 2 does not show Aspect 2 or Aspect 5.

[Aspect 1]: The adsorption material contains activated carbon and zeolite.

[Aspect 2]: The central particle size D50 of the activated carbon is 27 μm or more and 35 μm or less.

[Aspect 3]: The central particle size D50 of the zeolite is 24 μm or more and 31 μm or less.

[Aspect 4]: The content rate of the zeolite is 10 mass % or more and 70.5 mass % or less.

[Aspect 5]: A molded adsorbent can be prepared by molding.

Experimental Examples 2-1 to 2-5 showed a removal rate of 84% or more at the time when 1000 L of water was continuously passed, and the simulation test result of the lead removal test (pH 8.5) was 80% or more as a standard.

### 2.3 Experiment 3

Experimental Examples 3-1 to 3-8 shown in Table 4 were tested as follows to evaluate their performance. In this test, evaluation was performed through the test at pH 8.5. This test comprehensively evaluates the performance for removing particulate lead and soluble lead.

### (1) Test Method

The NFS/ANSI 53 lead removal test (pH 8.5) was conducted. The flow rate was 0.70 GPM (2.66 L/min), and the amount of water passed was 360 gal (1368 L).

### (2) Results and Discussion

The results are shown in Table 4 above. Experimental Examples 3-1 to 3-7 satisfy all of the following aspects 1 to 7. Table 2 does not show Aspect 2 or Aspect 5.

[Aspect 1]: The adsorption material contains activated carbon and zeolite.

[Aspect 2]: The central particle size D50 of the activated carbon is 27 μm or more and 35 μm or less.

[Aspect 3]: The central particle size D50 of the zeolite is 24 μm or more and 31 μm or less.

[Aspect 4]: The content rate of the zeolite is 10 mass % or more and 70.5 mass % or less.

[Aspect 5]: A molded adsorbent can be prepared by molding.

[Aspect 6]: The central particle size D50 of the adsorption material (indicated as “D50 in the total powder distribution (μm)” in the table) is 21 μm or more and 43 μm or less.

[Aspect 7]: The content rate of the adsorption material having a particle size of 10 μm or less (described as “Cumulative total of 10 μm powder (vol %)” in the table) is 1.7 vol % or more and 13.7 vol % or less.

On the other hand, the other experimental examples do not satisfy the following aspect. Experimental Example 3-8 does not satisfy Aspect 2, Aspect 4, Aspect 6, or Aspect 7.

In Experimental Examples 3-1 to 3-7, the pressure loss was 0.15 MPa or less, and the initial removal rate and the final removal rate were favorable. In particular,

Experimental Examples 3-5, 3-6, and 3-7 satisfying the following aspects 2′, 3, 4′, 6′, and 7′ had very favorable pressure loss, initial removal rate, and final removal rate.

[Aspect 2]: The central particle size D50 of the activated carbon is 33 μm or more and 35 μm or less.

[Aspect 3]: The central particle size D50 of the zeolite is 24 μm or more and 31 μm or less.

[Aspect 4]: The content rate of the zeolite is 15 mass % or more and 25 mass % or less.

[Aspect 6]: The central particle size D50 of the adsorption material (indicated as “D50 in the total powder distribution (μm)” in the table) is 25 μm or more and 35 μm or less.

[Aspect 7]: The content rate of the adsorption material having a particle size of 10 μm or less (described as “Cumulative total of 10 μm powder (vol %)” in the table) is 4.0 vol % or more and 7.0 vol % or less.

1. A molded adsorbent comprising an adsorption material and a fibrous binder,
wherein the adsorption material contains activated carbon and zeolite,
wherein a central particle size D50 of the activated carbon is 27 μm or more and 35 μm or less,
wherein a central particle size D50 of the zeolite is 24 μm or more and 31 μm or less, and
wherein a content rate of the zeolite is 10 mass % or more and 70.5 mass % or less.

2. The molded adsorbent of claim 1,
wherein a central particle size D50 of the adsorption material is 21 μm or more and 43 μm or less, and
wherein a content rate of the adsorption material having a particle size of 10 μm or less is 1.7 vol % or more and 13.7 vol % or less.

3. The molded adsorbent of claim 1,
wherein a content rate of the activated carbon is 23.5 mass % or more and 84 mass % or less, and
wherein a content rate of the fibrous binder is 2 mass % or more and 10 mass % or less.

4. The molded adsorbent of claim 1, wherein a pressure loss is 0.07 MPa or more and 0.15 MPa or less.

5. A water purification cartridge comprising the molded adsorbent of claim 1.
